(19) United States
(12) Patent Application Publication
(10) Pub. No.: US 2016/0028430 A1
(43) Pub. Date: Jan. 28, 2016

(54) SMART CASE FOR MOBILE DEVICES

(71) Applicant: New Wallet, Inc., Folsom, CA (US)

(72) Inventors: Karen Crawford, Folsom, CA (US); Jack Crawford, Folsom, CA (US)

(21) Appl. No.: 14/875,617

(22) Filed: Oct. 5, 2015

Related U.S. Application Data
(63) Continuation of application No. 14/520,832, filed on Oct. 22, 2014.
(60) Provisional application No. 61/910,865, filed on Dec. 2, 2013.

(51) Int. Cl. H04B 1/3888; H02J 7/02; H04W 4/00; H04M 1/21; H04M 1/02; H04M 1/725

(52) U.S. Cl. CPC H04B 1/3888; H04M 1/0262; H04M 1/7253; H04W 4/008; H04M 1/21; H02J 7/025; H04M 2001/0204

(57) ABSTRACT

Smart case with features including one or more of a locking door, flip ID, collapsible compartment, magnetic release and/or mechanical release to access ID, lanyard boss, tripod, programmable tactile buttons, wide/zoom camera lenses, keyless vehicle fob, fitness technology, lipstick/pen holder, retractable ear buds, magnetic card reader, battery, USB port, recharging technology, wireless charging receiver and tracking technology. A microchip, microcontroller, controller or processor with embedded or separate memory is configured or programmed to control the smart electronic features.

### CROSS REFERENCE

This application is a continuation of and claims priority to U.S. patent application Ser. No. 14/520,832 filed Oct. 22, 2014, which claims priority to Provisional Application No. 61/910,865 filed Dec. 2, 2013, which applications are incorporated herein for any and all purposes.

### FIELD OF THE INVENTION

The embodiments of the present invention relate to a smart case for mobile devices such as smart phones, tablets, personal digital assistants, pagers, integrated wallets and the like.

### BACKGROUND

Mobile devices are ubiquitous. In fact, there are more mobile devices in the United States than there are people. Smartphones and tablets dominate the mobile device market in the United States and worldwide. Smartphones and tablets are relatively expensive such that users tend to protect them from damage by using cases/covers adapted to retain such devices while not impeding user interaction. However, to date, such cases/covers suffer from lack of functionality beyond those protective in nature and a lack of significant features.

Thus, it would be advantageous to develop a mobile device case configured to protect the retained mobile device while permitting user interaction and including numerous advantageous features heretofore not available. Moreover, the mobile device case should be able to replace the conventional thick and clunky wallet.

### SUMMARY

The embodiments of the present invention are directed to a mobile device case configured to retain and protect the mobile device. Accordingly, the case may be fabricated of rigid materials, resilient materials and/or a combination thereof. More importantly, the case incorporates one or more features rendering the case “smart” rather than “dumb,” which is currently the norm.

Smart features include, but are not limited to, a locking door, flip ID, collapsible compartment, card holder mechanism, magnetic release to access ID, lanyard boss, tripod, programmable tactile buttons, wide/zoom camera lenses, keyless vehicle fob, fitness technology, lipstick/pen holder, retractable ear buds, magnetic card reader, battery, USB port, recharging technology, wireless charging receiver and tracking technology. Any of the one or more features may be incorporated in a case. Indeed, all of the features may be incorporated into a case as described herein.

Other variations, embodiments and features of the present invention will become evident from the following detailed description, drawings and claims.

### BRIEF DESCRIPTION OF THE DRAWINGS

FIG. 1 illustrates a perspective front view of a smart case on a smartphone according to the embodiments of the present invention;

FIG. 2 illustrates a perspective rear view of the smart case on a smartphone according to the embodiments of the present invention;

FIGS. 3A and 3B illustrate front and perspective views, respectively, of a smart case with an ergonomic design according to the embodiments of the present invention;

FIG. 4 illustrates a side view of the smart case on a smartphone according to the embodiments of the present invention;

FIG. 5 illustrates a top view of the smart case on a smartphone with lanyard bosses according to the embodiments of the present invention;

FIG. 6 illustrates a top view of the smart case on a smartphone according to the embodiments of the present invention;

FIG. 7 illustrates a rear view of the smart case on a smartphone according to the embodiments of the present invention;

FIGS. 8A and 8B illustrate multiple views of the smart case on a smartphone with a stand in use according to the embodiments of the present invention;

FIGS. 9A-9D illustrate multiple views of the smart case on a smartphone with a rotatable stand in use according to the embodiments of the present invention;

FIGS. 10A-10E illustrate multiple views of the smart case on smartphone with a card compartment in an open position according to the embodiments of the present invention;

FIGS. 11A and 11B illustrate multiple views of the smart case on smartphone with a card holder in an open position according to the embodiments of the present invention;

FIGS. 12A-12G illustrate multiple views of the smart case with an ID display in use according to the embodiments of the present invention;

FIG. 13 illustrates a smart case with an integral card reader according to the embodiments of the present invention;

FIG. 14 illustrates a smart case with an integral adapter for connection to a retained smartphone according to the embodiments of the present invention;

FIGS. 15A and 15B illustrate multiple views of a smart case with a door lock according to the embodiments of the present invention;

FIG. 16 illustrates recharging elements integrated on an interior of a smart case according to the embodiments of the present invention;

FIG. 17 illustrates a block diagram of the components of a smart case according to the embodiments of the present invention; and

FIGS. 18A-18C illustrate various transparent views of the smart case in use according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the embodiments of the present invention may involve both hardware and software elements which portions are described below in such detail required to construct and operate the smart case according to the embodiments of the present invention.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing. The program code may be updated via Over-The-Air (OTA) updates.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The embodiments of the present invention relate to a mobile device case and/or wallet. As used herein the term “case” may relate to any cover or protective article for retaining and/or protecting the mobile device. While the embodiments of the present invention may be suitable for any type of mobile device, including a tablet and PDA, a smartphone is used herein to describe the case.

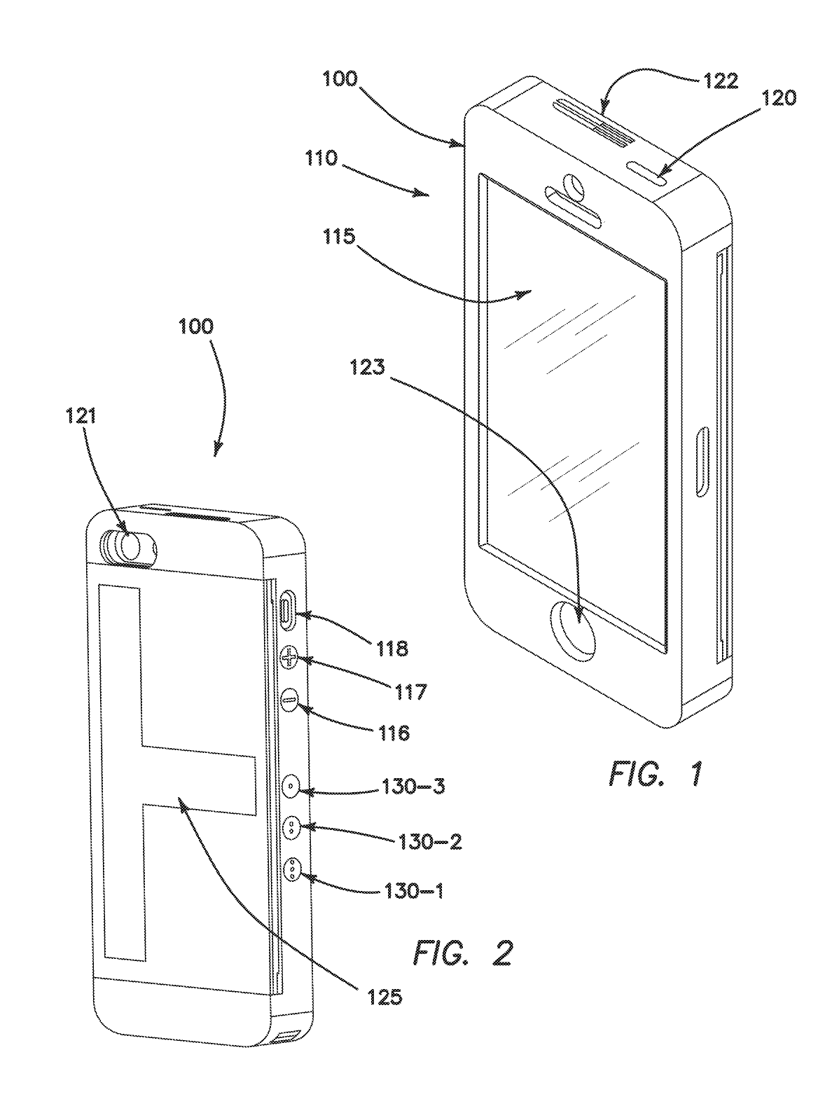

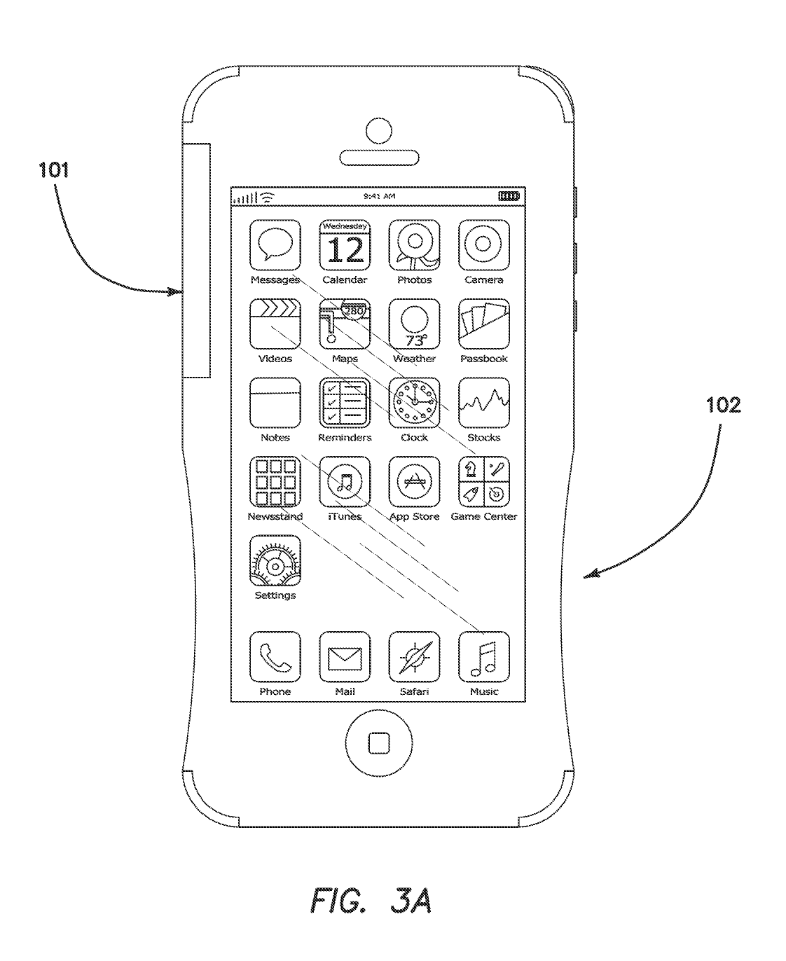

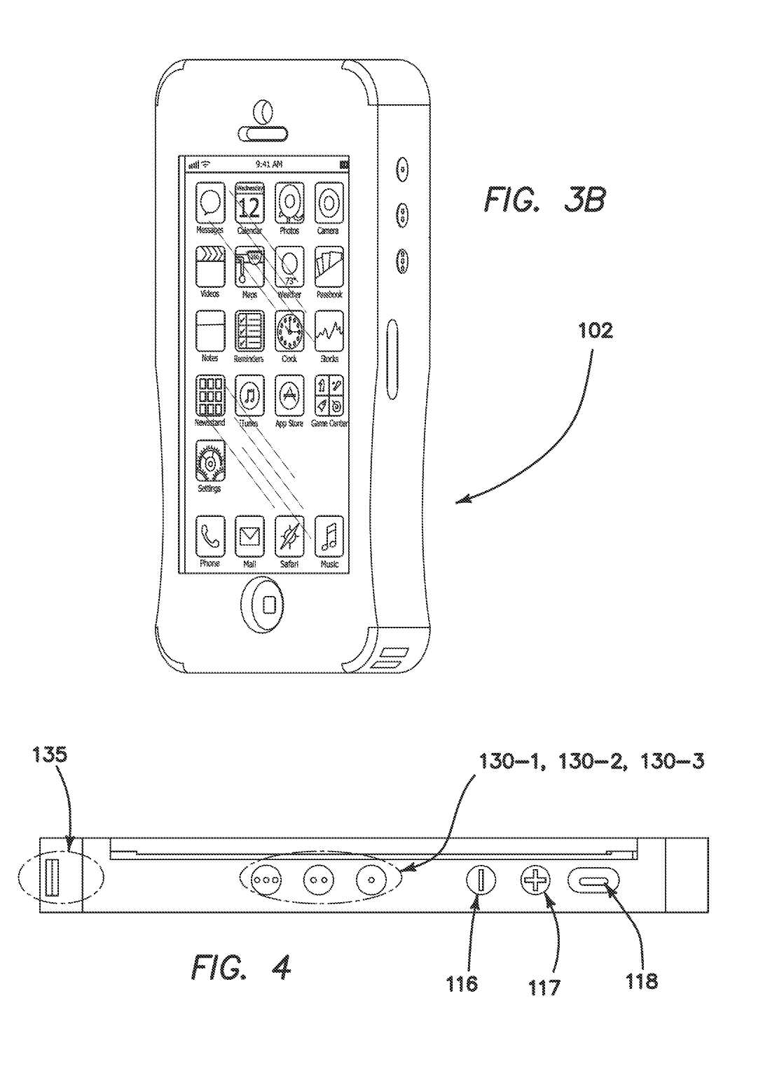

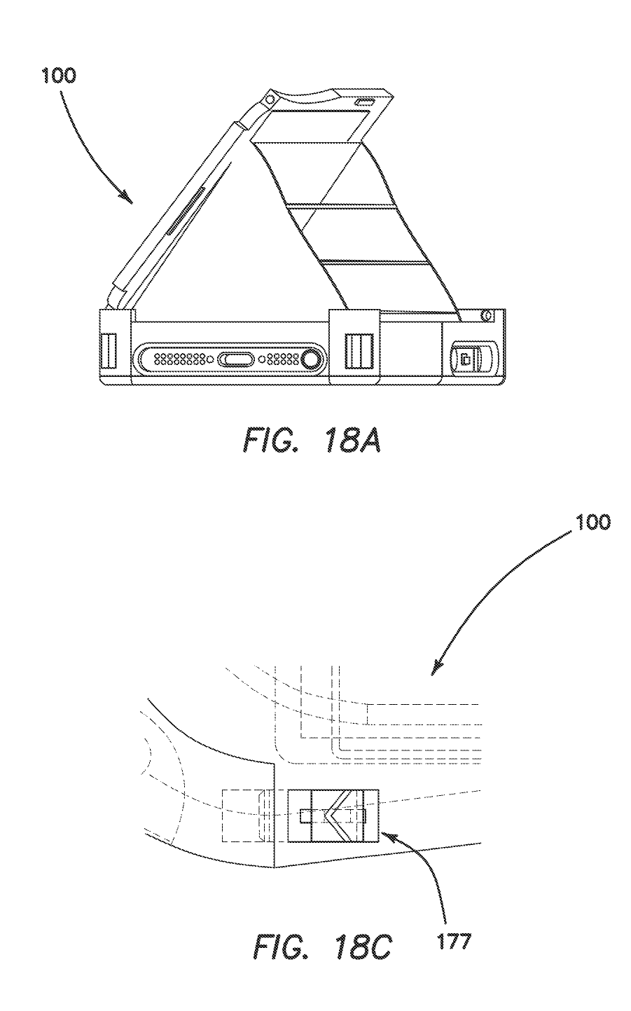

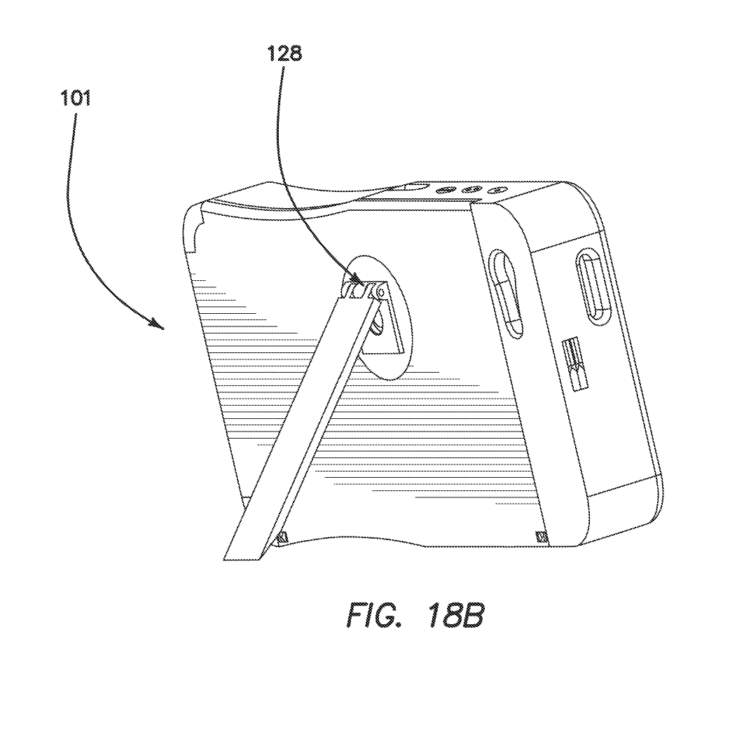

FIGS. 1 through 7 show perspective front, perspective rear, rear, side and top views, respectively, of a smart case 100 on a smartphone 110 according to the embodiments of the present invention. In general, the smart case 100 is fabricated of a rigid material, resilient material or combination thereof and is configured to retain and/or protect the smartphone 110 from damage. The case 100 includes numerous cutouts to accommodate certain smartphone 110 functionalities including a display 115, volume down button 116, volume up button 117, sound on-off button 118, power adapter 119, power button 120, camera lens 121, port 122 and home button 123. FIGS. 3A and 3B show front and perspective views, respectively, of a smart case 101 with an ergonomic design represented by the slight contours 102 along its height. FIGS. 18A-18C show various views of the smart case 101 in use.

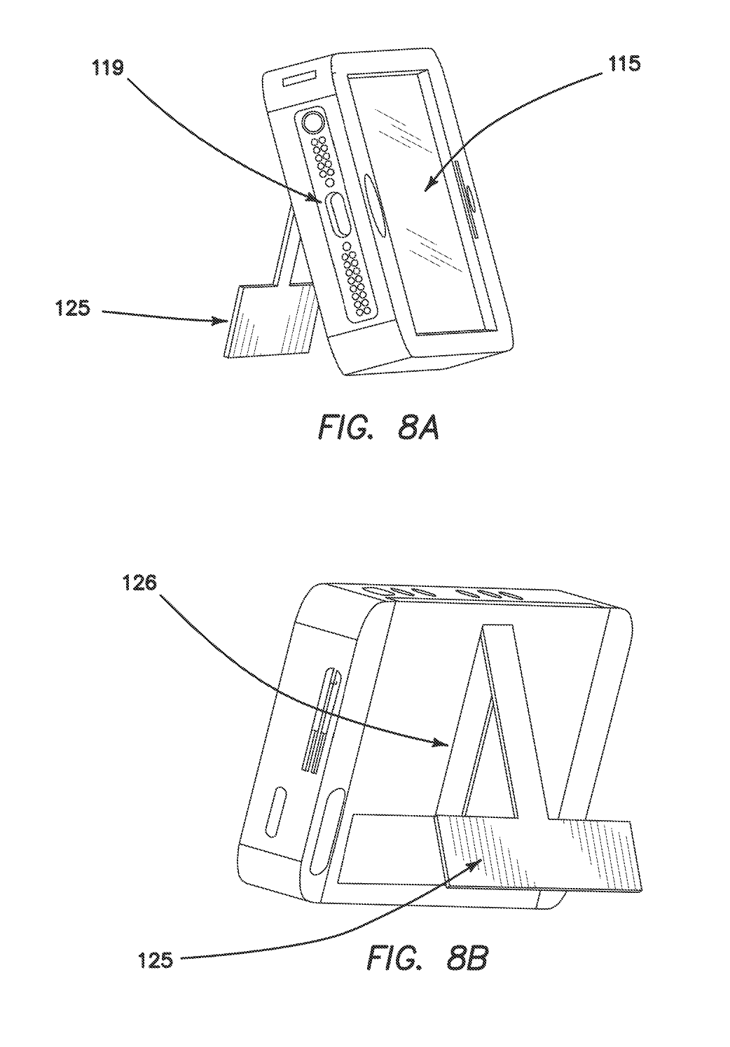

FIG. 7 shows an integral tripod or stand 125 in a stored position within the rear of the smart case 100. FIGS. 8A and 8B show the stand 125 in an open position supporting the smartphone 110 for hands free use to conduct calls, view content and interact via the touchscreen display. In one embodiment, the stand 125 is T-shaped, rests in a similarly-shaped cavity 126 in a rear of the smart case 100 and rotates about one end from an open to stored position and vice versa. Rotation may be facilitated by a hinge device or a pre-stressed portion at said one end.

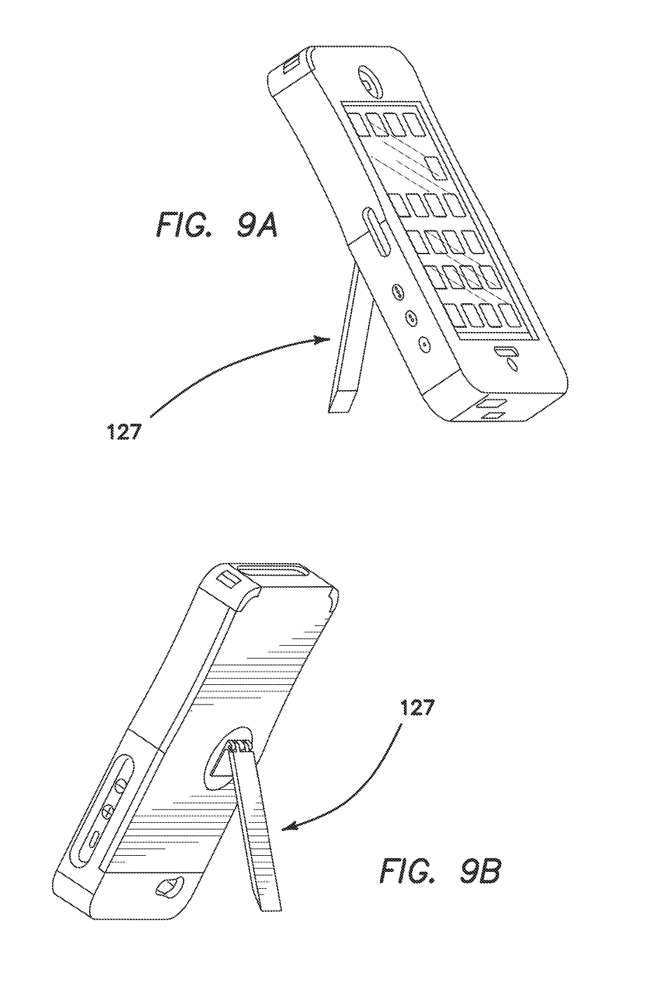

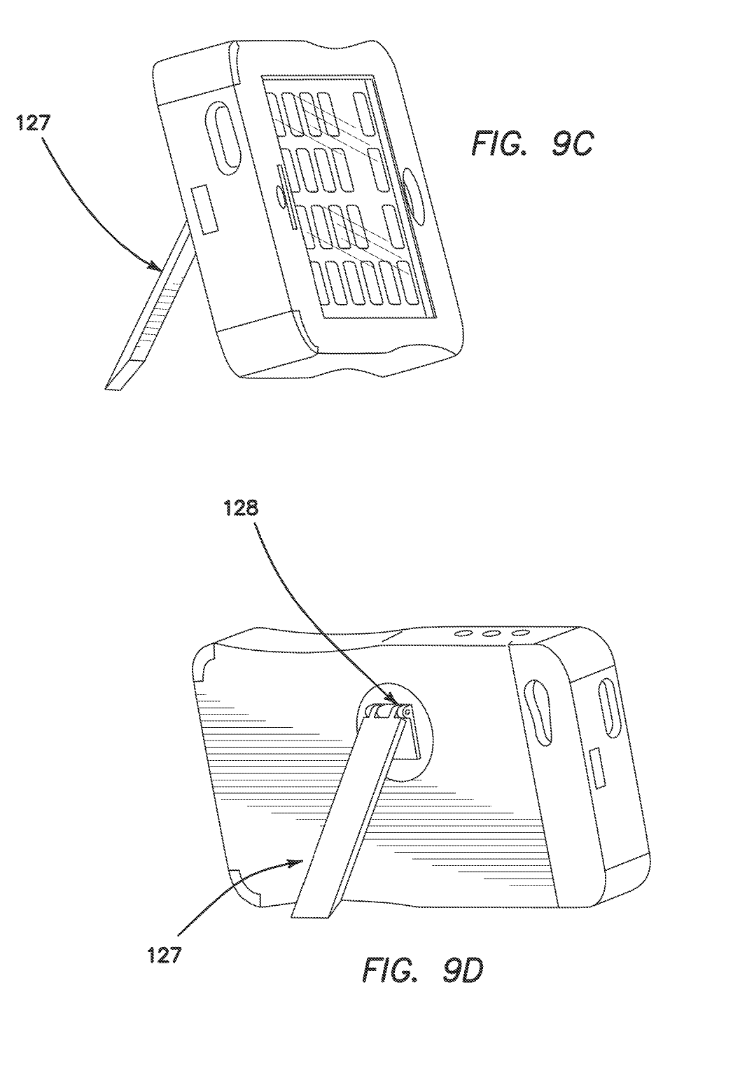

FIGS. 9A-9D and 18B illustrate multiple views of the smart case 100 and smart phone 101, respectively, on the smartphone 110 with a rotatable stand 127 in use according to the embodiments of the present invention. The stand 127 permits the smartphone 110 to be placed in a horizontal or vertical orientation. A swivel member 128 is joined to a rear of the smart case 100 and smart case 101 in a central position or offset therefrom. The swivel member 128 may rotate up to 360 degrees but at least 90 degrees allows the mobile device to be supported along both edges (e.g., length and width).

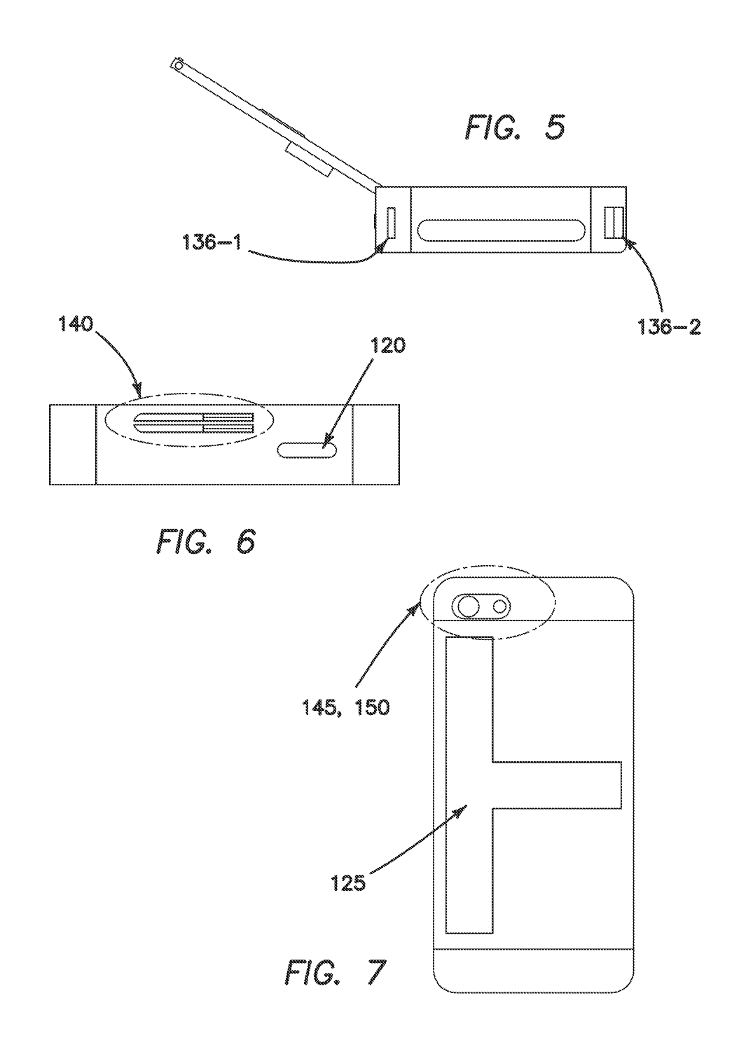

FIG. 4 shows three tactile buttons 130-1 through 130-3 configured to trigger an embedded transmitter controller chip, or wireless (Bluetooth Low Energy, WiFi, or similar communication protocol) access to a LAN or WAN web-service which communicates with a connected devices directly or via a connected gateway, which have been configured to operate a synced device. For example, the transmitter chip may be programmed to control a garage door or gate opener. In one embodiment, the transmitter controller chip is paired with a garage door opener and stores a rolling code which allows access to the garage door when the button is pressed. In another embodiment, the transmitter controller chip is paired with an automobiles door locking controller and stores a rolling code which allows the automobiles door to lock/unlock when the button is pressed. In practice, the tactile buttons 130-1 through 130-3 may be synced by the user with a specific garage door opener to operate the garage door accordingly or with a specific automobiles door lock/unlock mechanism to operate the automobiles car door accordingly. The synchronization of the various control buttons is accomplished in the same way that the individual remote devices of these entrance controllers are performed. The coding for the digital signal is wirelessly received and stored in memory and is assigned to the appropriate function button. This is the digital modulation that is sent on the RF carrier when the button is engaged. FIG. 4 also shows a lanyard boss 135 for receiving a lanyard to conveniently carry the case 100 and retained smartphone 110. FIG. 5 shows dual lanyard bosses 136-1 and 136-2.

FIG. 6 shows a dual switch 140 for moving between a wide angle lens 145 and zoom lens 150 (as shown in FIG. 7) in cooperation with the standard smartphone camera lens. The switch 140 has two members enabling the wide angle lens 145 and zoom lens 150 to be moved as desired over the standard smartphone camera lens thereby modifying the camera view and resultant digital photo.

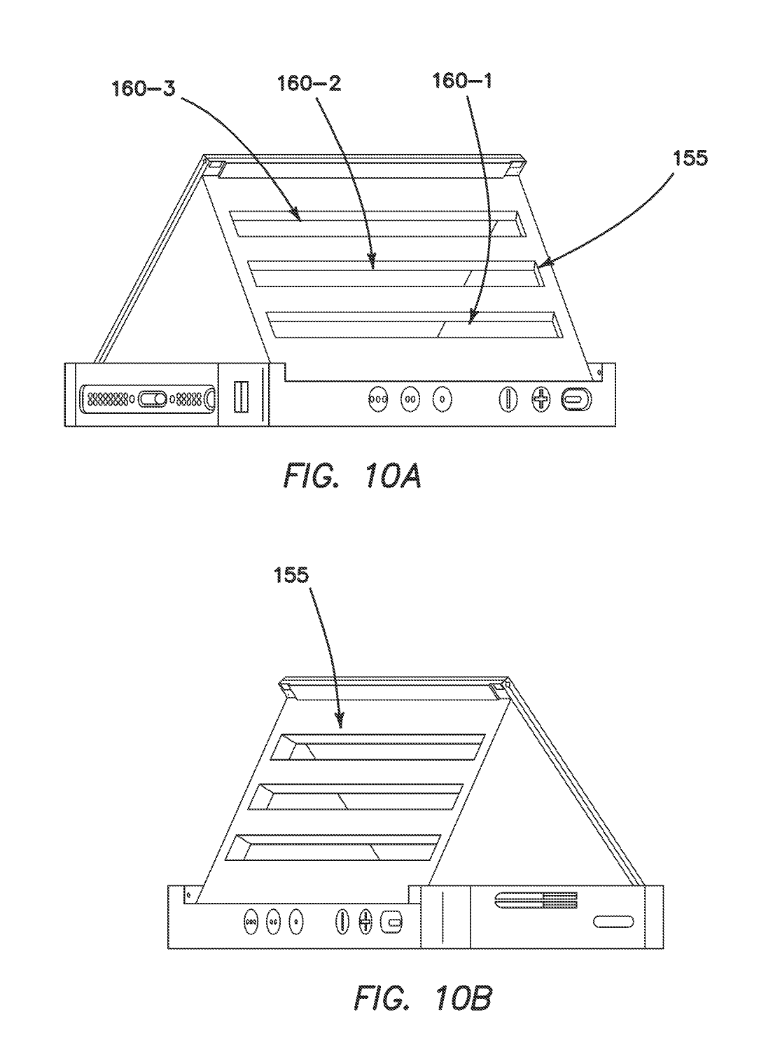

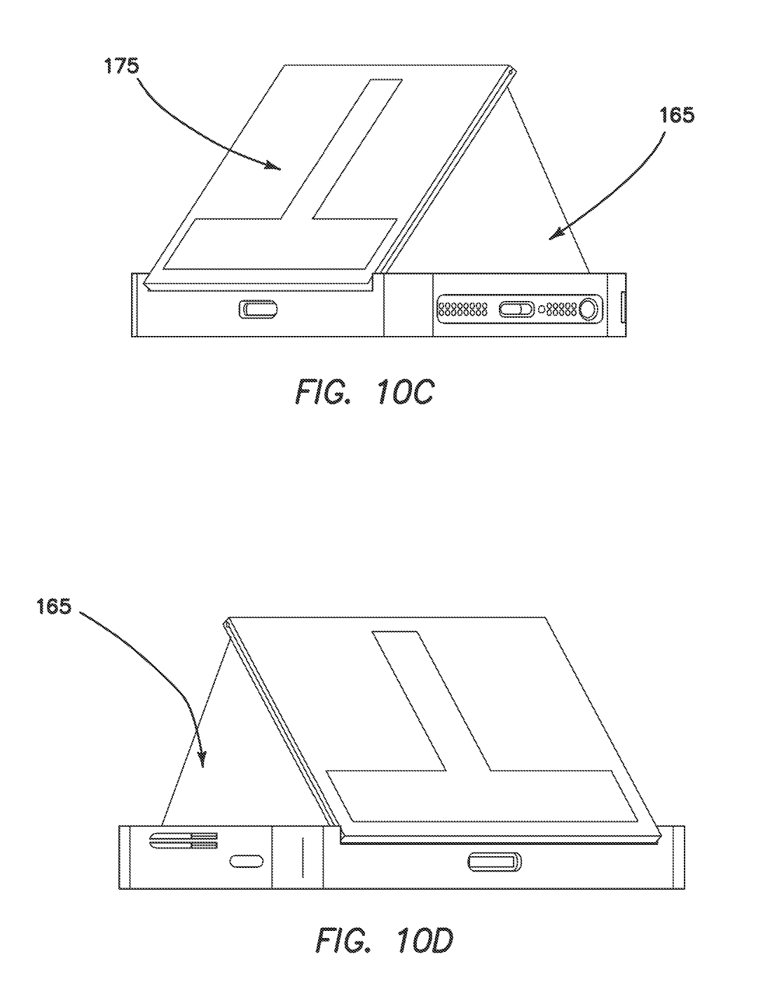

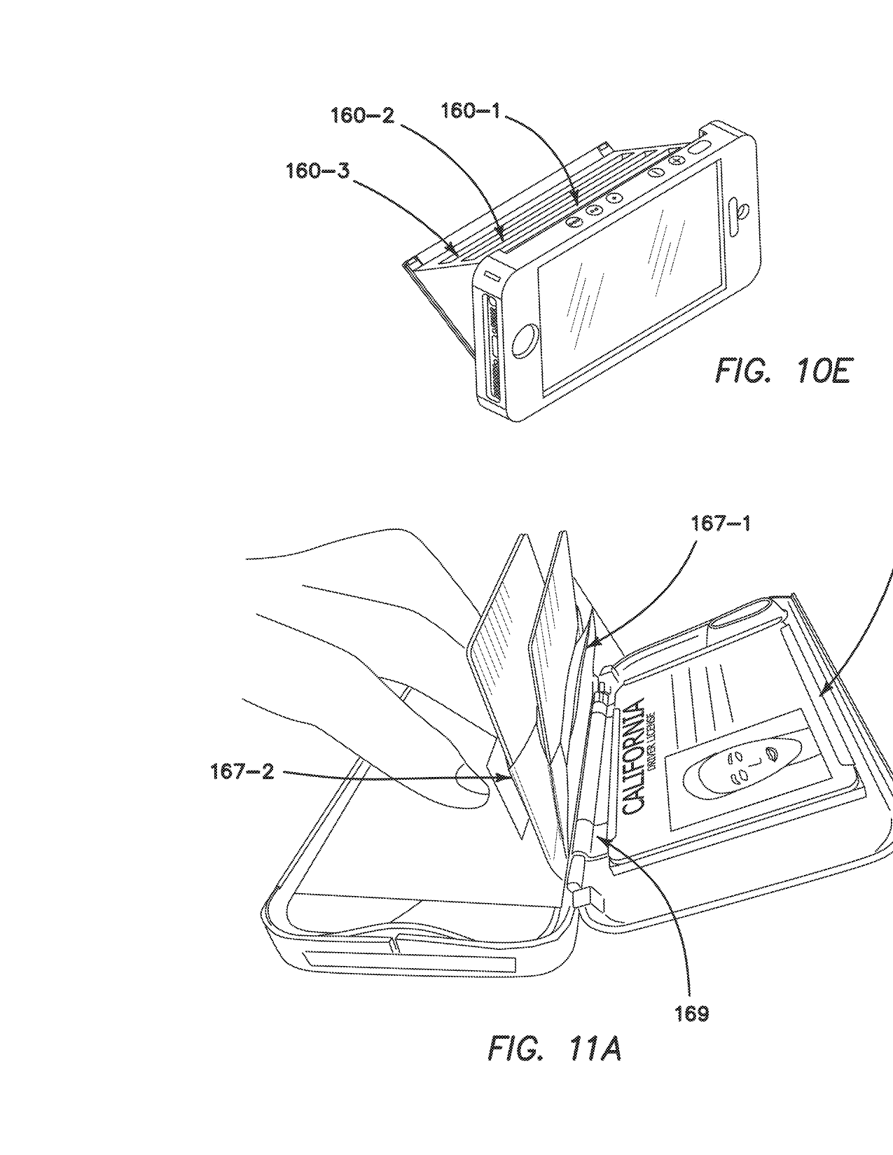

FIGS. 10A-10E show multiple views of the case 100 with a compartment 155 in an open position. The “fan style” compartment includes, as shown, three slots 160-1 through 160-3 configured to retain credit cards, cash and the like. Foldable side members 165 permit the compartment 155 to open and close. The side members 165 may be made of a resilient type of material such as nylon rendering the side members 165 collapsible. The rear wall of the compartment 155 acts as a door 175 supporting the compartment 155 and rotating open and closed about one side, via a hinge or pre-stressed portion, thereof and closing flush with the smart case 100.

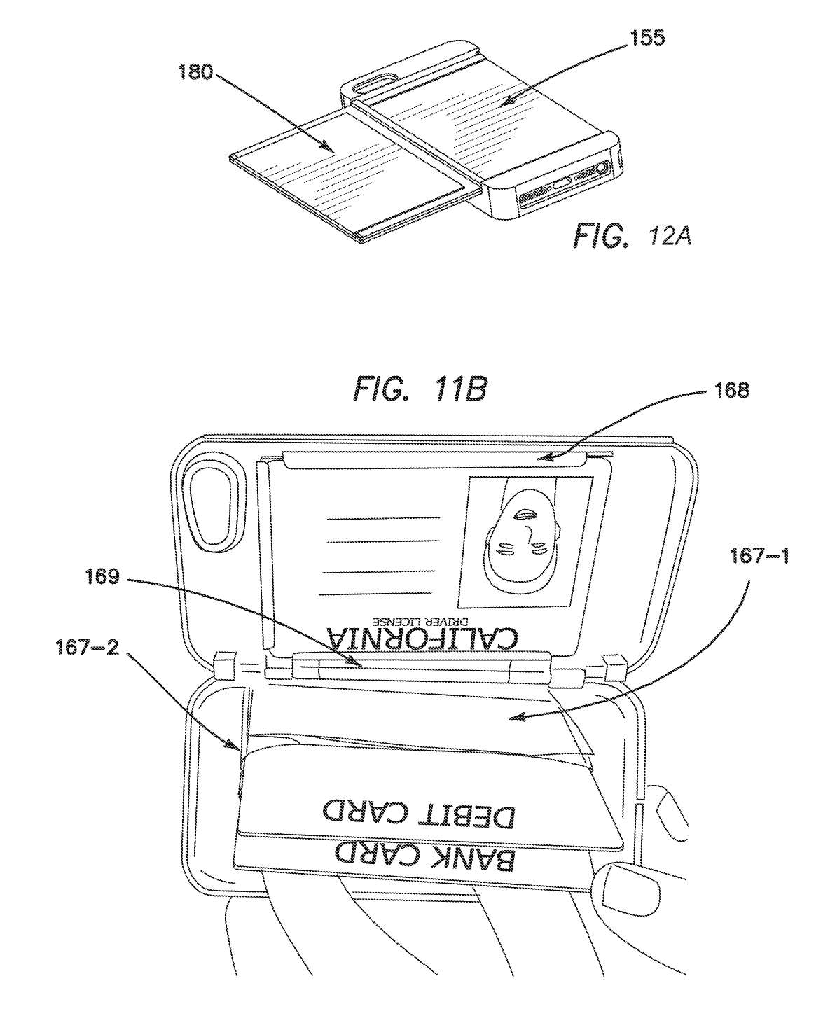

FIGS. 11A and 11B show multiple sleeves 167-1 and 167-2 rotatable about a common spine 169 wherein the sleeves 167-1 and 167-2 are configured to each retain an identification card, credit card, debit card or the like. When not in use, the sleeves 167-1 and 167-2 lay on top of each other within the housing of the case 100. There can be more or less than two sleeves 167-1 and 167-2. A slot 168 retains another card, such as a user's identification. The slot 168 may be fixed or rotatable about the spine 169.

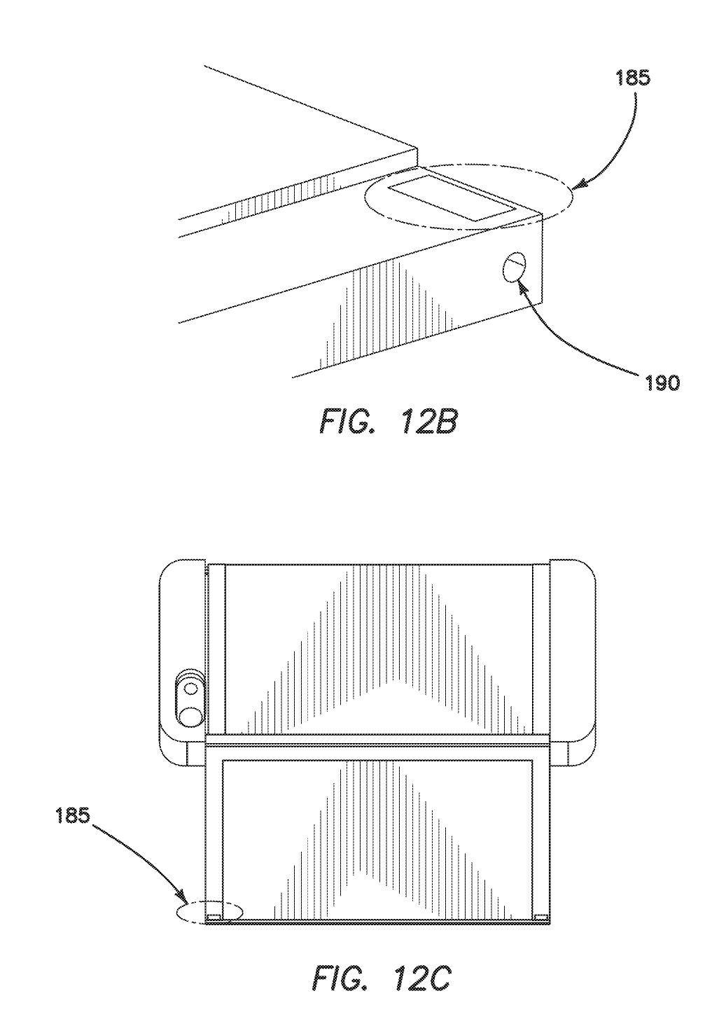

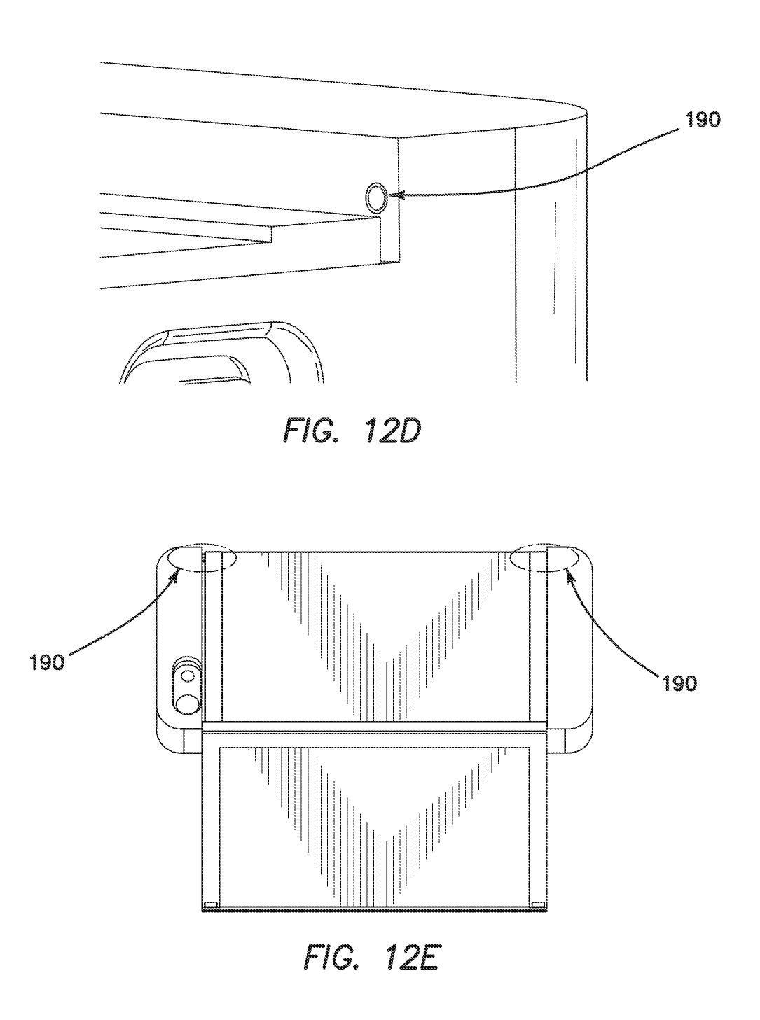

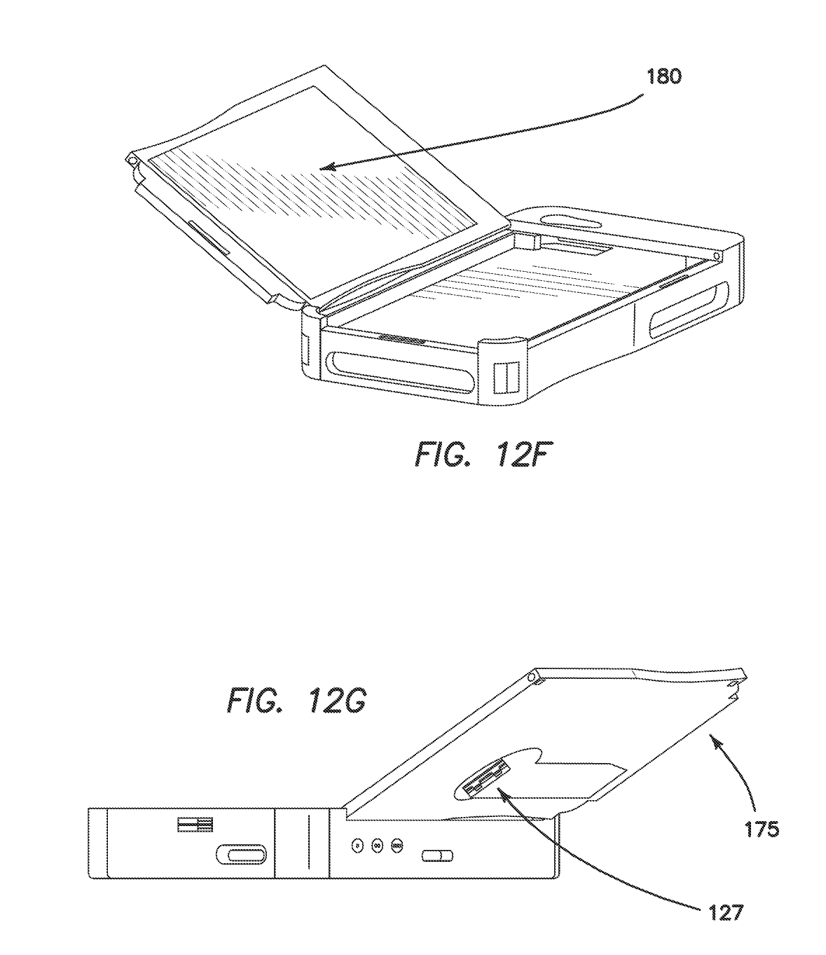

FIGS. 12A-12G show multiple views of an ID pocket 180 on an inner surface of the door 175. As shown, the door 175 of the compartment 155 may be released from the fan portion to rotate (without the fan portion) thereby revealing the ID in a clear sleeve or the like without having to remove the same. In one embodiment, an electronic locking pin assembly 185 comprising locking members 190 permits attachment and detachment of the door 175 from the fan portion of the compartment 155 for revelation of the ID.

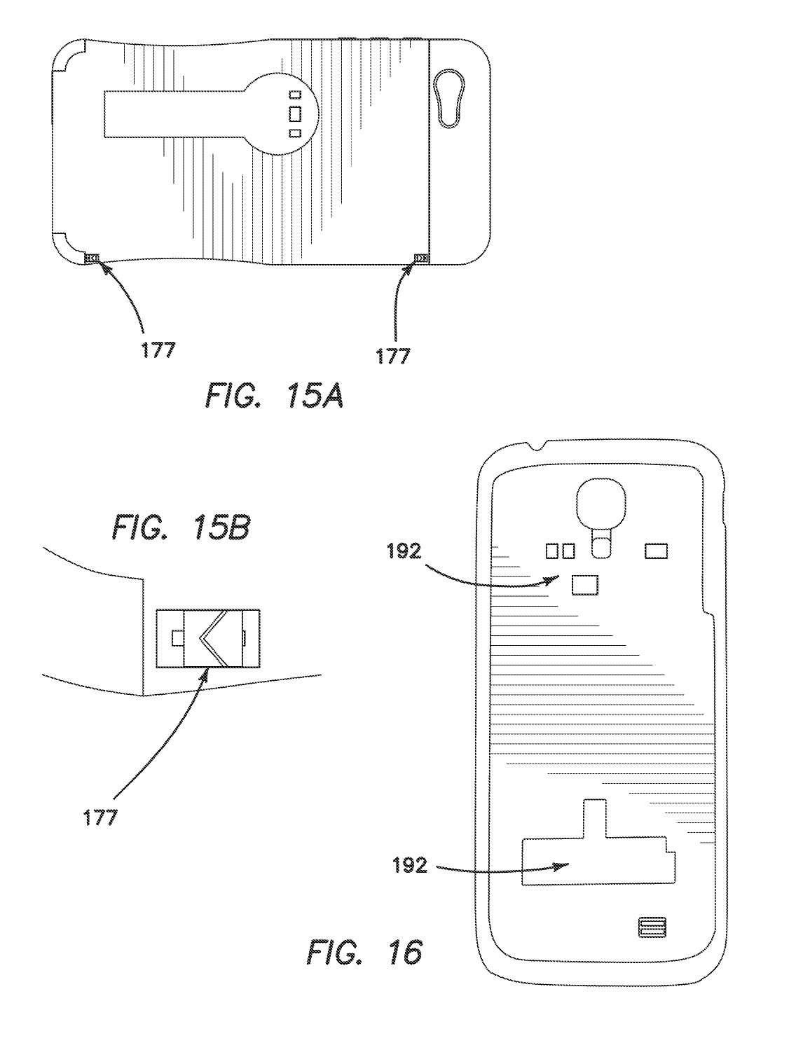

In one embodiment, the door 175 incorporates a locking mechanism. In one such embodiment, a sliding lever lock is incorporated. In another embodiment, touch security, utilizing finger print technology, retina scanning technology and/or similar biometric technology, is integrated into the smart case 100 as a means for unlocking the door 175. In another embodiment, a mobile device operated password lock system is utilized. With such a locking system, a communication link between the smartphone 110 and smart case 100 allows a user to enter a password on the display of the smartphone 110 to release electronically locking door 175. In this instance, the smart case 100 communicates the verification of the password to the smartphone 110 thereby unlocking the door 175. FIGS. 15A and 15B illustrate multiple views of the smart case 100 with a sliding door lock 177.

In another embodiment, the locking mechanism or release is a roller style padlock or programmable magnets, which require action (e.g., via passcode lock in app, or tapping a pattern on the back of the smart case 100 or pushing one of the included buttons on the side to a pattern or a touch gesture pattern on the smart case 100), for unlocking the door 175.

In another embodiment, a location feature comprises Morse code or gesture-based pattern recognition, either running on the smart device via an included and synced app, or embedded in the back of the smart case 100 with a communication link between the smart case 100 and the smart device via BLE or physical connection, such that a cloud service can monitor the status (e.g., closed, open or locked) of the door 175 and report location and time of any incident which can then be routed to a safe number/family member to alert them of possible theft/loss.

In another embodiment, a SaaS model is embedded into the smart case 100 with a companion application. The smart case 100 includes embedded electronics (BLE, etc.) that communicate with a paired application even when the smart device is not in the smart case 100. Such a pairing provides security features such as monitoring the status of the smart case 100 and providing lost instructions to any individual finding the smart case 100 as well as privately locating the smart case 100, monitoring the door 175 status (door locked/not opened, door opened, cards removed from slot(s), ID removed, smart device removed from smart case 100, smart device and smart case 100 no longer within minimum distance from one another (e.g., 100+meters for BLE), etc. In the card holder (e.g., as shown in FIG. 10E), embedded sensors detect whether the slot is empty or not, removing a card triggers a log of the activity such that if the smart case 100 is in lost mode, a trigger sends an email/SMS/in-app message to a secure address alerting the owner (or authorized user) of the event. For example, if the door 175 is forced open during “lost mode,” the owner and spouse may receive an SMS alerting them to contact the bank and put a hold on any credit or debit cards along with information about the location of the smart case and/or instructing the application to take photos every 20-seconds and upload them to a secure server in the background as a visual log.

In one embodiment, the smart case incorporates keyless car starting technology. Remote keyless systems (RKS) use an electronic remote control as a key which is activated by a physical button on the smart case 100 or automatically by proximity. When within a few yards of the car, pressing a button on the smart case 100 locks or unlocks the doors, and may perform other functions. A remote keyless system can include both a remote keyless entry system (RKE), which unlocks the doors, and a remote keyless ignition system (RKI), which starts the engine. Such technology enables a synced vehicle to be started as long as the smart case 100 is inside of the vehicle or within a user defined range. In essence, the smart case 100 serves the same purpose and function of the keyless fob devices provided by so many vehicle manufacturers currently.

In one embodiment, the smart case 100 incorporates fitness technology. In such an embodiment, the smart case 100 contains a receiver that receives a signal from a heart rate monitor strap worn around the user's chest or other mechanism to detect to heart rate and other biometric data. The signal alerts the receiver at which rate the individual's heart is beating. Embedding the receiver into the smart case 100, rather than a smart watch for example, eliminates the need for the user to wear a smart watch and rely on the mobile device case 100 which people carry already. Heart rate is but one form of medical feedback that the receiver may be configured to receive.

In one embodiment, a lipstick or pen holder snaps-on the smart case 100 or is integral therewith. The holder may contain a pen, stylus or lipstick or lip gloss pen.

In another embodiment, the smart case 100 includes retractable ear buds which may be stored in the smart case 100 about a pulley or similar device. A spring-loaded pulley causes the ear bud cord to retract automatically into the smart case 100 or extend therefrom when desired. In another embodiment, a retractable cable permits plug-in re-charging of the electronic components of the smart case 100 via a charging adapter. The cable may directly charge or transfer data via a USB male adapter on an exposed end of the cable configured to mate with a USB female port/wall charger or USB female port/car charger or a USB female port/PC for data transfer, etc.

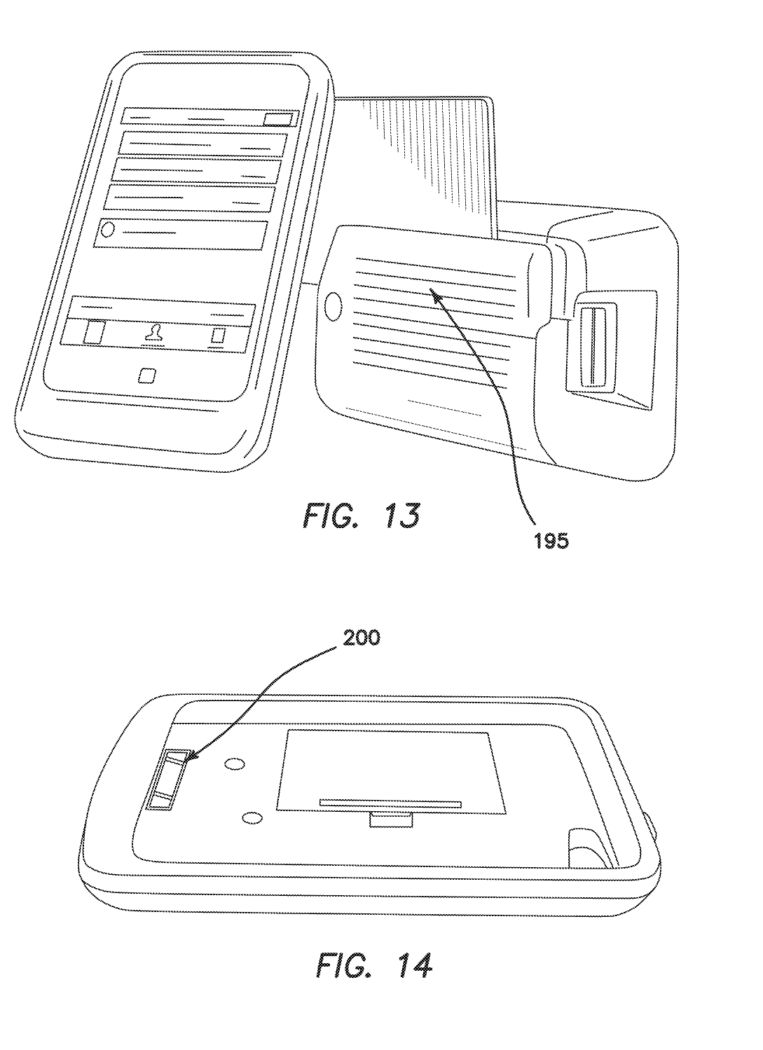

In one embodiment, as shown in FIG. 13, the case 100 includes a card reader 195 suitable for merchants or others. The card reader 195 enables card swiping and reading of magnetic strips on credit and debit cards to facilitate payments and cash transfers. The electronics of the card reader 195 are integrated into the smart case 100.

In another embodiment, the smart case 100 includes a secondary battery for extending the life of the retained smartphone.110 FIG. 14 shows the smart case 100 with a charging adapter 200 integral therewith. In this manner, the battery included in the smart case 100 may transfer power to the retained smartphone 110 via the adapter 200. The smart case 100 may also incorporate a rechargeable battery 201.

In another embodiment, the smart case 100 incorporates one or more communications ports such as a USB port. The USB port accepts an external flash drive to transfer data, documents and photos without the need for an Internet connection. The USB port may also be used for powering the smart case 100 and therefore smartphone 110 through the power adapter 200. Other communication ports (e.g., firewire) may be integrated in the smart case 100 as well.

Other embodiments include one or more solar cells and wireless charging receiver allowing the smart case and therefore smartphone to be charged. A special “recharge mat,” having a special power transmitter can transmit electrical energy via an alternating electromagnetic field without a direct (plug) connection to the smartphone 110. Inductive charging (wireless charging) uses an electromagnetic field to transfer energy between two objects. This is usually done with a charging station. Energy is sent through an inductive coupling to an electrical device, which can then use that energy to charge batteries or run the device. Induction chargers typically use an induction coil to create an alternating electromagnetic field from within a charging base station, and a second induction coil in the portable device takes power from the electromagnetic field and converts it back into electrical current to charge the battery. The two induction coils in proximity combine to form an electrical transformer. The smartphone 110 itself must have a compatible electromagnetic receiver in order for the energy to be transferred. In this situation, the receiving antenna is integrated into the smart case 100. The receiving antenna in the smart case 100 is then connected to the smartphone 110 via a wired connection. Solar recharging may be incorporated into the smart case 100 as well. In one embodiment, a solar cell is connected to a wireless recharging receiver. FIG. 16 shows recharging elements 192 integrated into the smart case 100.

RFID or GPS tracking technology may also be embedded in the smart case 100 for tracking or locating the retained smartphone. Signals sent by the tracking technology may be tracked using another mobile device or computer. The tracking technology may also be used to locate other items (e.g., keys, glasses, etc.) in proximity to the smart case 100. For example, specific items may be tagged to communicate with the smart case 100. Using Bluetooth Low Energy (BLE) or similar short range communication technology, the smart case 100 may trigger an alarm when the smart case 100 and the tagged item are more than a pre-established distance apart (e.g., 100 feet). In another embodiment, the smart case 100 may instruct the smart device to take photos for various purposes.

The smart case 100 may further incorporate near field communication to communicate with the contained smartphone or other devices in proximity thereto. Near field communication (NFC) is a standard for very short-range radio transmission. Thus, the smart case 100 incorporates a NFC chip as part of the near field communication module 350. The NFC chip is programmed to communicate with passive NFC tags via a radio field which is decoded to provide information or exchange information.

In another embodiment, the smart case 100 is configured to act as a key for various applications. In one embodiment, the smart case 100 may act as a security key for commercial building entry, vehicle access, residential home access and the like. In such an embodiment, the smart case 100 contains a re-writeable smart card microchip (e.g., a control chip) that can be transcribed via radio waves which is required to communicate via radio waves to the subject security systems central administration system through card reading devices, such as ticket readers, building door entry systems, ATMs, etc. The data comprises identification information, encrypted security information, authorization and verification information and the like as specified by ISO/IEC 14443.

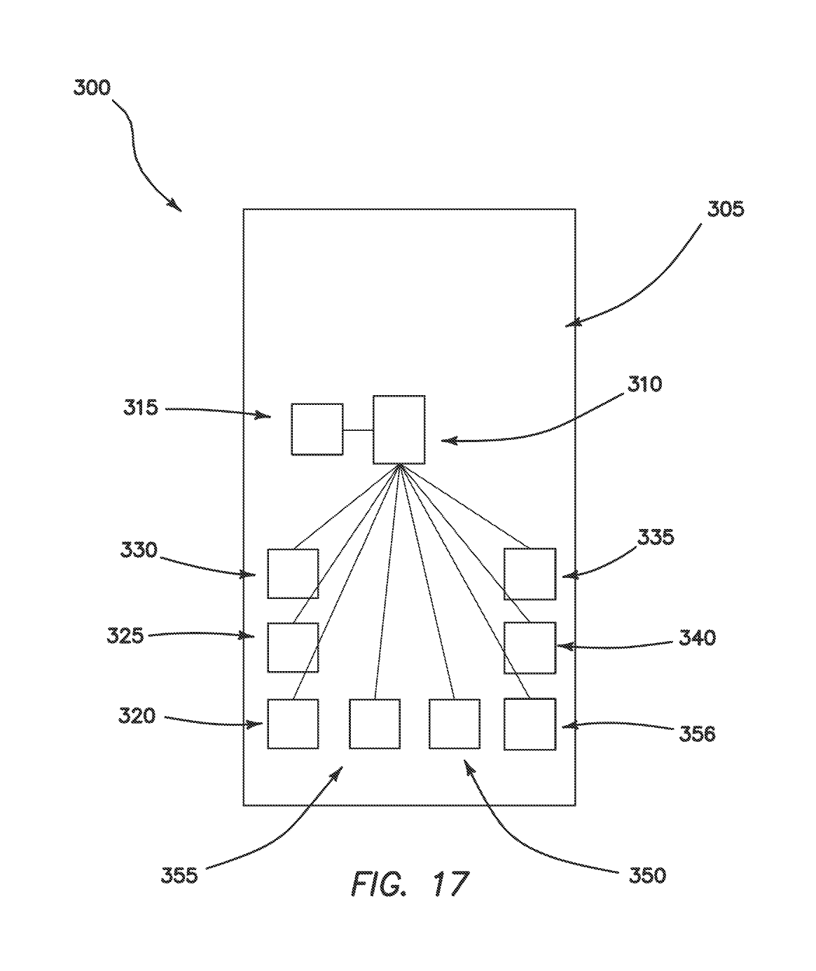

FIG. 17 shows a block diagram 300 of a smart case 305 comprising components relevant to a smart case as detailed herein. A control chip 310 is programmed to manage and control the smart features of the smart case 305. The control chip 310 may be any microchip, microcontroller, processor or the same (collectively “controller”). A memory chip 315 communicates with the control chip 310. The control chip 310 may also incorporate its own memory. The control chip 310 may run/control various software modules and corresponding hardware including a programmable tactile buttons module 320, keyless vehicle starting module 325, fitness module 330, card reader module 335, wireless charging receiver module 340, tracking module 345, near field communication module 350 and keyless entry module 355. The smart case 305 may include each and every module or only certain of the features.

Although the invention has been described in detail with reference to several embodiments, additional variations and modifications exist within the scope and spirit of the invention as described and defined in the following claims.

I claim:

1. A case for a mobile device comprising:
a body configured to receive a mobile device;
memory embedded in said body; and
a controller embedded in said body and configured to control one or more electronic features of said case.

2. The case of claim 1 further comprising a card reader, said card reader in communication with said controller.

3. The case of claim 1 further comprising a communication port.

4. The case of claim 1 further comprising tracking means for locating said case and retained mobile device.

5. The case of claim 1 further comprising a wireless charging receiver.

6. The case of claim 1 further comprising one or more solar cells.

7. The case of claim 1 further comprising a near field communication chip configured to provide near field communications.

8. A case for a mobile device comprising:
a body configured to receive a mobile device;
a battery compartment configured to retain one or more batteries; and
a mobile device charging adapter configured to mate with a mobile device charging port such that said one or more batteries are able to charge said mobile device.

9. A case for a mobile device comprising:
a body configured to receive a mobile device;
memory embedded in said body;
a controller embedded in said body and configured to control one or more electronic features of said case.
a battery compartment configured to retain one or more batteries;
a transmitter embedded in said body; and
one or more programmable tactile buttons configured to operate one or more synced devices.

10. The case of claim 9 wherein said one or more synced devices include a garage door opener and/or gate opener.

11. A case for a mobile device comprising:
a body configured to receive a mobile device;
memory embedded in said body, said memory configured to receive and store digital codes;
a signal transmitter; and
a controller embedded in said body and configured to cause said digital codes to be utilized to provide keyless entry and/or keyless vehicle starting.
